(19) United States
(12) Patent Application Publication
(10) Pub. No.: US 2011/0089639 A1
(43) Pub. Date: Apr. 21, 2011

(54) Remote control target base

(76) Inventors: Jason Earl Bellamy, Calabash, NC (US); Brett Allen Howard, Conway, SC (US)

(21) Appl. No.: 12/925,220

(22) Filed: Oct. 14, 2010

Related U.S. Application Data
(60) Provisional application No. 61/252,261, filed on Oct. 16, 2009.

(51) Int. Cl. F41J 9/00; B62D 1/24

(52) U.S. Cl. 273/359; 180/167

(57) ABSTRACT

A remotely controlled, motorized shooting practice platform is described that includes a chassis with a bottom wall having an upper surface, and a removable top wall with an upper surface; a plurality of wheels carried on fixed axles supporting the chassis; a plurality of DC powered motors operatively attached to the axles, whereby the wheels rotate when the motors are energized; a battery mounted on the bottom wall upper surface; a controller mounted on the bottom wall upper surface for controlling the amount of current from the battery to each of the motors; a receiver mounted on the bottom wall upper surface providing control signals to the controller; a transmitter remote from the chassis to transmit control signals to the receiver; target attachment means mounted upon the top wall upper surface of the chassis; and a target extending about the chassis and attached to the chassis with the target attachment means.

This application claims the benefit of the filing date of Provisional Application Ser. No. 61/252,261, filed Oct. 16, 2009, entitled “A Remote Control Target Base With Wireless Remote”, the application being incorporated herein by reference in its entirety.

### BACKGROUND OF THE INVENTION

(1) Field of the Invention

The present invention relates to a shooting practice target, and in particular to a target comprised of a motorized platform, or target base, that can be controlled by wireless remote control.

(2) Description of the Prior Art

Numerous target designs are available for hunters who wish to practice their shooting skills, either with firearms or bow and arrows. Most of the available targets are stationary. Stationary targets are of limited value since they only provide a practice opportunity under one set of terrain and distance conditions, unless the target or the shooter's position changes. Repositioning of the target is not only time consuming, but may be hazardous if others are shooting in the vicinity of the target. While the shooter may change position, the options may be limited and the target still remains in the same terrain.

U.S. Pat. No. 7,469,902 to Hale describes a target that attempts to provide a more varied practice experience. Basically, the Hale target is comprised of a motorized, wheeled platform that is tethered to a central stake. The platform may support a target, such as a silhouette of a deer. When the platform drive mechanism is energized, the platform travels along a circular pathway with a radius equal to the length of the tether. While this target provides improvements over stationary targets, the movement is repetitive and an open area as large as the diameter of the circle traveled by the platform. Also, with the Hale design, a relatively level area is required to prevent tipping of the platform.

Thus, there is a continuing need for a mobile target that provides a more varied shooting experience and challenge, and in particular a shooting platform that can be used to transport a shooting target to remotely selected locations.

### SUMMARY OF THE INVENTION

The present invention is directed to a mobile apparatus for shooting target practice, and in particular to a remotely controlled mobile platform adapted to support different targets and move along pathways selected remotely from the platform. The platform is designed for high stability, allowing movement of the platform with supported target across uneven terrain without tipping.

Generally, the apparatus of the invention is comprised of a wheeled, motorized platform, a remotely controlled drive mechanism, and one or more targets mountable on the platform. The motorized platform is comprised of a chassis, a plurality of wheels supporting the chassis, power sources to rotate the wheels, and attachment means to secure a target to the platform. The chassis is comprised of a horizontal floor with an upper surface and upwardly extending side and end walls, and a removable top with an upper surface.

The remotely controlled drive mechanism is comprised of electric motors in communication with each of the wheels, e.g., by way of rotatable axles, with the wheels being affixed to the axles. The electric motors are powered by batteries mounted on the floor of the chassis. A controller receives electrical current from the batteries and transmits the current to the individual motors, which are independently controlled.

A receiver receives control signals from a remote transmitter and transmits instructions to the controller. Instructions determine how much current is to be conveyed to each of the motors, which in turn determines the rotational speed of the wheels associated with the motors.

The drive mechanism may also include a master switch to activate or deactivate the drive mechanism. Preferably, the switch, which may be lockable, is mounted for ease of access on a wall of the chassis. The drive mechanism may also include a charger port for use in recharging the batteries.

The targets may be of any desired design. For example, the target may be the silhouette of a deer or other game animal, or a conventional bullseye target. Each target is releasably mountable on the platform. Mounting means is located on the upper surface of the platform top for this purpose, with mating mounting means being provided on the bottom of the target. For example, the target may include downwardly extending sockets, while the target mount includes upwardly extending pins or pegs that are insertable into the sockets. The mounting means may also include a locking means to secure the target to the platform. For example, slidable clamps may be provided to clamp the target sockets. It will be apparent upon reading the present description that other means to releasibly secure the target to the platform can be used.

In use, the desired target is mounted on the platform and the drive mechanism is energized. Signals are sent from the transmitter to the receiver, instructing the controller to provide current independently to the drive motors. If the platform is to move directly ahead, then equal current is provided to all motors. If the platform is to be turned to the right, relatively more current is provided to the motors driving the wheels on the left of the platform, while relatively more current is provided to the motors driving the wheels on the right side of the platform if the platform is to turn to the right. Thus, by transmitting the appropriate signals, the platform can be commanded to move along any selected pathway at a desired speed, with the pathway being determined by the remote operator at any given time.

### BRIEF DESCRIPTION OF THE DRAWINGS

FIG. 1 is a side view of platform with a deer silhouette target attached.

FIG. 2 is a top view of the platform.

FIG. 3 is a top view of the platform with the top cover removed to show the interior components.

FIG. 4 is a front view of a typical handheld transmitter.

FIG. 5 is a front view of a bullseye target.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

As illustrated in the drawings, a preferred embodiment of the invention is comprised of a mobile platform, generally 10, supporting a target 12. Platform 10 is comprised of a chassis 14 supported of four wheels 16. Chassis 14 includes a floor or bottom wall 20 having an upper surface, side walls 22 and 24, end walls 26 and 30, and a detachable top wall 32 having an upper surface. Wheels 16 may be of a variety of materials, e.g., plastic, rubber, metal, pneumatic, foam filled, etc., depending on the terrain over which the platform is driven.

Each of wheels 16 is carried on a fixed axle 34 driven by brushless DC motor 36. While shown in the drawings for simplicity as directly linked to motors 36, is will be understood that axle 34 may also be connected through gearing. Motors 36 are mounted on motor supports 38. Motors 36 are powered by battery pack 40, which may be a single battery or a group of batteries. Sealed lead, Ni-Cad and Lithium batteries are examples of the kinds of batteries that can be used.

Motors 36 are independently controlled from controller 42, which is adapted to provide levels of current to each of the motors for battery pack 40. The level of current provided to each of motors 36 is determined in response to commands received from receiver 44. Receiver 44 receives commands from handheld radio control transmitter 46, which is operated remotely by the shooter or another person from a location remote from platform 10. Transmitter 46 is of conventional design and is battery powered. As illustrated, transmitter 46 includes two joystick or toggle controls 50 and 52 and an antenna 54. Platform 10 includes antenna 56 to receive transmissions from transmitter 46. Transmitter 46 may be configured so that toggle 50 controls the left-hand motors, while toggle 52 controls the right-hand motors.

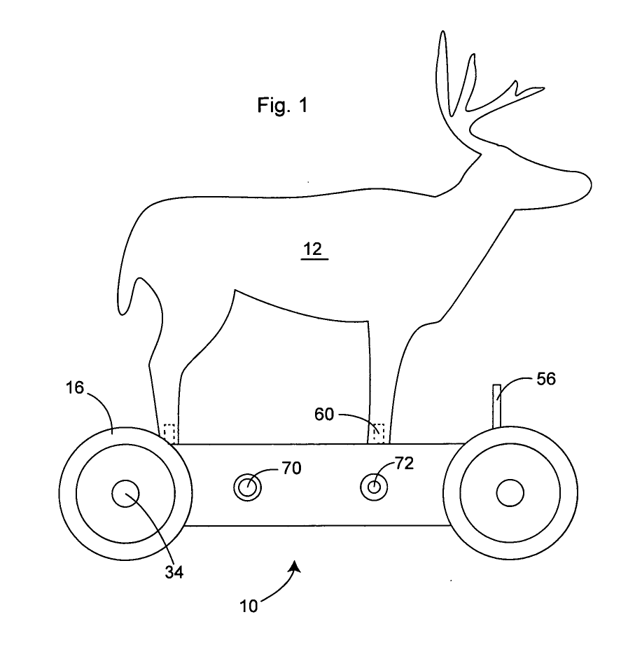

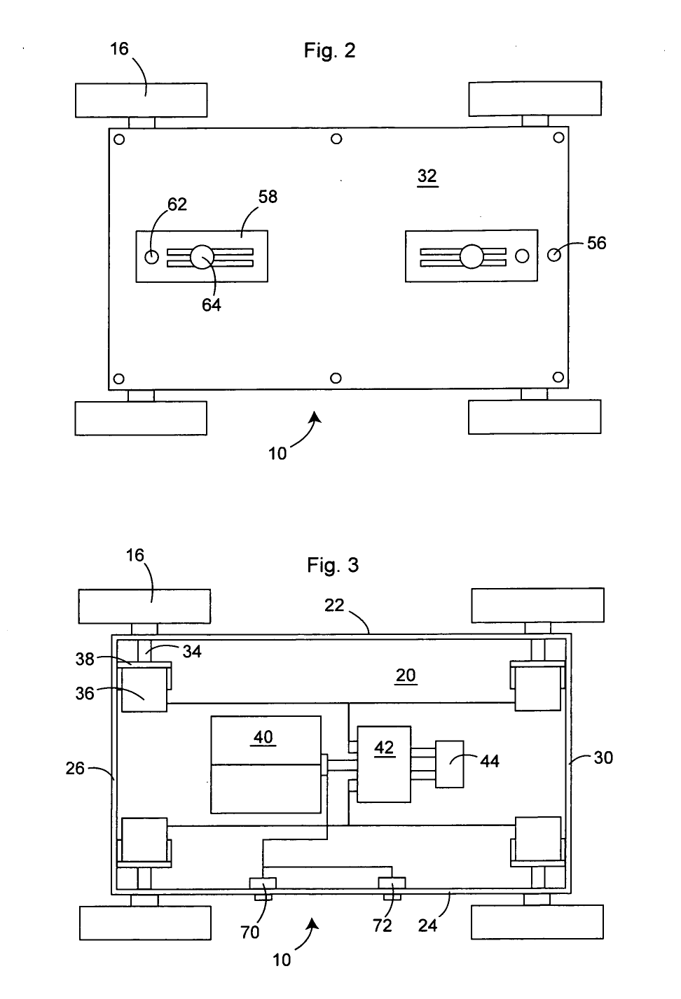

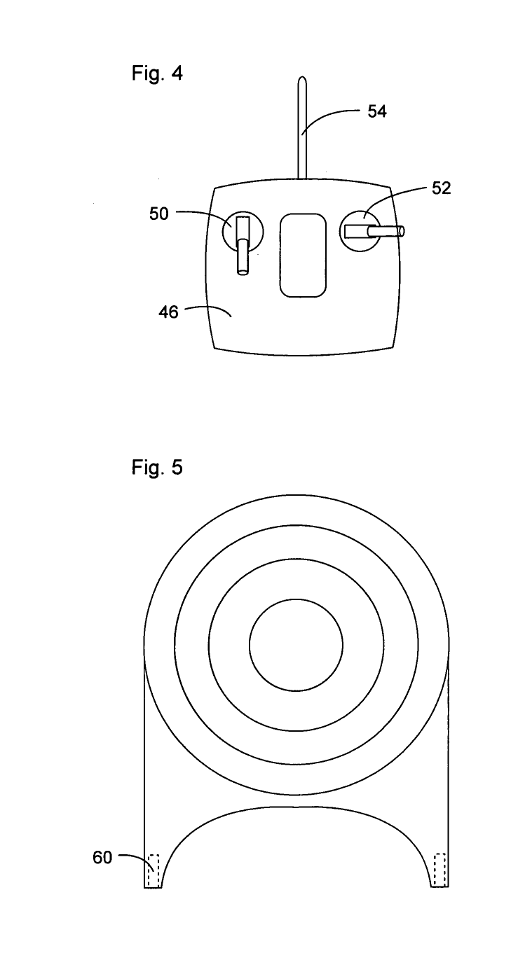

Target 12 is illustrated in FIG. 1 as a deer silhouette. It will be understood that the invention is not limited to any particular design. One alternative design of a bullseye target is illustrated in FIG. 5. Targets are detachably mountable on the upper surface of wall 32 with target attachment means 58. As illustrated in the preferred embodiment, each target includes sockets 60 for insertion of pins 62 mounted on the top of platform top wall 32. Locking mechanisms 64 are used to lock pins 62 in sockets 60.

The circuit connecting battery pack 40 to motors 36 also includes a charger socket 70 for use in recharging battery pack 40, and a master switch 72 for use in opening the circuit to prevent unintended or unauthorized use. Switch 72 may be lockable.

In use, the circuit connecting battery pack 40 and motors 36 is closed with switch 72. Command signals are transmitted from transmitter 46 to controller 42 via receiver 44 to send a predetermined amount of current to each motor 36. Depending on the relative amount of current sent to each motor, the platform moves ahead, to the left, or to the right. The amount of current also determines the speed of the platform.

Major weight components, i.e., battery pack 40, controller 42 and receiver 44 are mounted on the upper surface of chassis bottom wall 20, which is below the plane of axles 34. As a result, the low center of gravity of the platform prevents tipping of the platform, even when driven rapidly over rough terrain.

Certain modifications and improvements will occur to those skilled in the art upon a reading of the foregoing description. For example, instead of using one motor connected to each axle, the front motors can be replaced with a servo steering mechanism. Alternatively, two of the motors can be removed and replaced with a drive connection, such as chains and sprockets, pulleys and belts, or metal or nylon gears. It should be understood that all such modifications and improvements have been deleted herein for the sake of conciseness and readability but are properly within the scope of the following claims.

What is claimed is:

1. A remotely controlled, motorized target platform adapted to support a shooting target comprising:
a) a chassis;
b) a plurality of wheels carried on fixed axles supporting said chassis;
c) a plurality of DC powered motors operatively attached to said axles, whereby said wheels rotate when said motors are energized;
d) a battery;
e) control means for controlling the amount of current from said battery to each of said motors,
f) a receiver providing control signals to said controller; and
g) a transmitter remote from said chassis to transmit control signals to said receiver.

2. The platform of claim 1, wherein said chassis is supported on four wheels.

3. The platform of claim 1, wherein said chassis includes a bottom wall, side walls, end walls, and a removable top wall.

4. The platform of claim 1, wherein said chassis includes target attachment means with upstanding pins insertable into sockets in said target.

5. A remotely controlled, motorized target platform adapted to support a shooting target comprising:
a) a chassis including a bottom wall with an upper surface, side walls, end walls, and a removable top wall with an upper surface;
b) a plurality of wheels carried on fixed axles supporting said chassis;
c) a plurality of DC powered motors operatively attached to said axles, whereby said wheels rotate when said motors are energized;
d) a battery mounted on the bottom wall upper surface;
e) a controller mounted on the bottom wall upper surface for controlling the amount of current from said battery to each of said motors,
f) a receiver mounted on the bottom wall upper surface providing control signals to said controller;
g) a transmitter remote from said chassis to transmit control signals to said receiver; and
h) target attachment means mounted upon the top wall upper surface of said chassis.

6. The platform of claim 5, wherein said chassis is supported on four wheels.

7. The platform of claim 5, wherein said target attachment means includes upstanding pins insertable in sockets in said target.

8. The platform of claim 7, wherein said target attachment means includes locking means to secure said pins in said sockets.

9. The platform of claim 5, wherein said axles are in a given plane, and said bottom wall upper surface is in a plane below said given plane.

10. The platform of claim 5, wherein said target attachment means include front and back sections, each section having an upwardly extending pin.

11. A remotely controlled, motorized shooting practice platform comprising:
a) a chassis including a bottom wall with an upper surface, side walls, end walls, and a removable top wall with an upper surface;
b) a plurality of wheels carried on fixed axles supporting said chassis;
c) a plurality of DC powered motors operatively attached to said axles, whereby said wheels rotate when said motors are energized;
d) a battery mounted on the bottom wall upper surface;
e) a controller mounted on the bottom wall upper surface for controlling the amount of current from said battery to each of said motors,
f) a receiver mounted on the bottom wall upper surface providing control signals to said controller;
g) a transmitter remote from said chassis to transmit control signals to said receiver;
h) target attachment means mounted upon the top wall upper surface of said chassis; and
i) a target extending about said chassis and attached to said chassis with said target attachment means.

12. The platform of claim 11, wherein said target includes downwardly extending sockets and said target attachment means includes upwardly extending mounting pins insertable into said sockets.

13. The platform of claim 11, wherein said target attachment means is comprised to front and rear longitudinally adjustable sections, each section including a mounting pin.

14. The platform of claim 11, wherein said target is the silhouette of a deer.

15. The platform of claim 11, wherein said target is a bullseye target.
